(19) United States
(12) Patent Application Publication
(10) Pub. No.: US 2007/0005728 A1
(43) Pub. Date: Jan. 4, 2007

(54) System and method of queued web services

(76) Inventors: Ian Elbury, New Westminster (CA); Rastislav Hodul, Port Moody (CA)

Correspondence Address: PERMAN & GREEN, 425 POST ROAD, FAIRFIELD, CT, 06824, US

(21) Appl. No.: 11/172,458

(22) Filed: Jun. 30, 2005

(51) Int. Cl. G06F 15/16

(52) U.S. Cl. 709/218

(57) ABSTRACT

A queued web services system and method of queuing web services is provided. The queued web services system comprises a QWebRequest module for queuing a data post request in a queue, and a QDaemon module for monitoring the queue and submitting the data post request from the queue. The method comprises the steps of queuing a data post request in a queue, monitoring a network for a network connection, and submitting the data post request when a connection is available.

### FIELD OF INVENTION

The present invention relates generally to distributed mobile applications, and in particular, to a system and method of queued web services.

### BACKGROUND OF THE INVENTION

Currently, mobile devices communicate through networks. Typically, the mobile device operates remotely on a radio frequency to a host'server. In order for a web service to operating on a mobile device, the mobile device requires a connection to a server. Unfortunately, there are times when radio coverage and/or server is not available.

Web services is a World Wide Web Consortium (W3C) standard for inter application communication. This standard requires the two applications/computers to be connected via the Internet at the time the client application needs to send the web service request to the server. In a mobile environment, the Internet connection is not always guaranteed, yet there is a need to make the web service request transparent to the user and developer.

A user is not able to post data when radio coverage is not available. A user would have to save the data locally on the mobile device and remember to post it at later time. This requires the user to spend time operating a save feature on the mobile device (assuming the user is given appropriate permissions to save on the mobile device), spend time monitoring whether radio coverage becomes available, and spend time reattempting to post the data.

### SUMMARY OF THE INVENTION

The present invention relates to distributed mobile applications where data collection can take place in environments with and without radio (or other telecommunication) coverage. It is an object of the present invention to provide a system and method of queued web services.

In accordance with an embodiment of the invention, there is provided a queued web services system for providing queued web services. The queued web services system comprises a QWebRequest module for queuing a data post request in a queue, and a QDaemon module for monitoring the queue and submitting the data post request from the queue.

In accordance with another embodiment of the invention, there is provided a method of queued web services. The method comprises the steps of queuing a data post request in a queue, monitoring a network for a network connection, and submitting the data post request when a connection is available.

Advantageously, the queued web services system and method of queueing web services is transparent to the user. A user does not have to actively initiate the data posts once a connection is available. The user does not need to know or care if she is connected to the Internet or any other communications network.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows in a network diagram an example of a system overview of a design, development and operational environment, in accordance with an embodiment of the invention;

FIG. 2 shows in a layer diagram another example of a system overview of a design, development and operational environment, in accordance with an embodiment of the invention;

FIG. 3 shows a queued web services system, in accordance with an embodiment of the invention;

FIG. 4 shows in a flowchart an example of a method of queued web services, in accordance with an embodiment of the queued web services system;

FIG. 5 shows another example of a queued web services system; and

FIG. 6 shows another example of a method of queued web services, in accordance with an embodiment of the queued web services system.

### DETAILED DESCRIPTION

The following description is of a preferred embodiment.

The present invention will be further illustrated in the following examples.

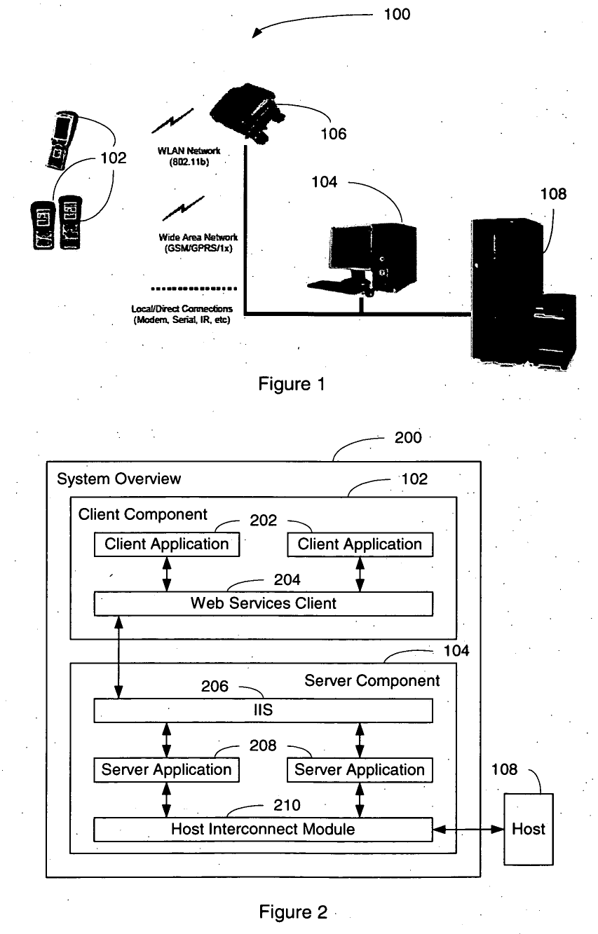

FIG. 1 shows in a network diagram an example of a system overview 100 of a design, development and operational environment for deploying feature rich applications (that use web services) to mobile devices and desktop personal computers, in accordance with an embodiment of the invention. The system overview 100 comprises one or more or mobile client components (or handheld terminals) 102 for allowing a user to collect, review and modify data; a server component 104 for providing applications and connectivity options to external systems; a network 106 for allowing the handheld terminals 102 to communicate with the server component 104 via a communications protocol; and a back-end system (or host) 108 for providing a database or enterprise resource planning (ERP) system. Examples of mobile components include personal computers (PCs), vehicle mount computers, tablet PCs, and devices with embedded operating systems, etc.

FIG. 2 shows in a layer diagram another example of a system overview 200 of a design, development and operational environment, in accordance with an embodiment of the invention. The mobile client component 102 comprises one or more client applications 202 that communicate with a web services client 204. The server component 104 comprises an Internet information server ([IS) 206 for communicating with the web services client 204, one or more server applications 208 and a host interconnect module 210 for communicating with the host (or back-end system) 108. The server applications 208 communicate with both the IIS 206 and the host interconnect module 210.

An application console may be installed as client application 202 on the mobile client component 102 to provide a presentation layer and application framework that end users use to collect, review and modify data. The application console communicates with the server component 104 via web services running on the IIS 206. The server component 104 is a middle tier where data is synchronized before being sent to the back-end system 108.

The server component 104 provides the applications and connectivity options to integrate back-end systems 108. A unified administration console for administering middleware on may be installed as a server application 206 to provide a single source for system management and monitoring and can be used remotely. Advantageously, the unified administrative console simplifies multi-site, multi-device management and deployment. This allows for ease of deployment and controlled rollouts. Host interconnect modules 210 provide the information and logic used to integrate with the back-end systems 108.

Back-end systems 108, whether databases or full-featured enterprise resource planning (ERP) systems, are supported via the host interconnect modules 210 installed on the server component 104. Standard interface technologies are supported, including extensible markup language (XML) and open database connectivity (ODBC), as well as ERP-specific interfaces.

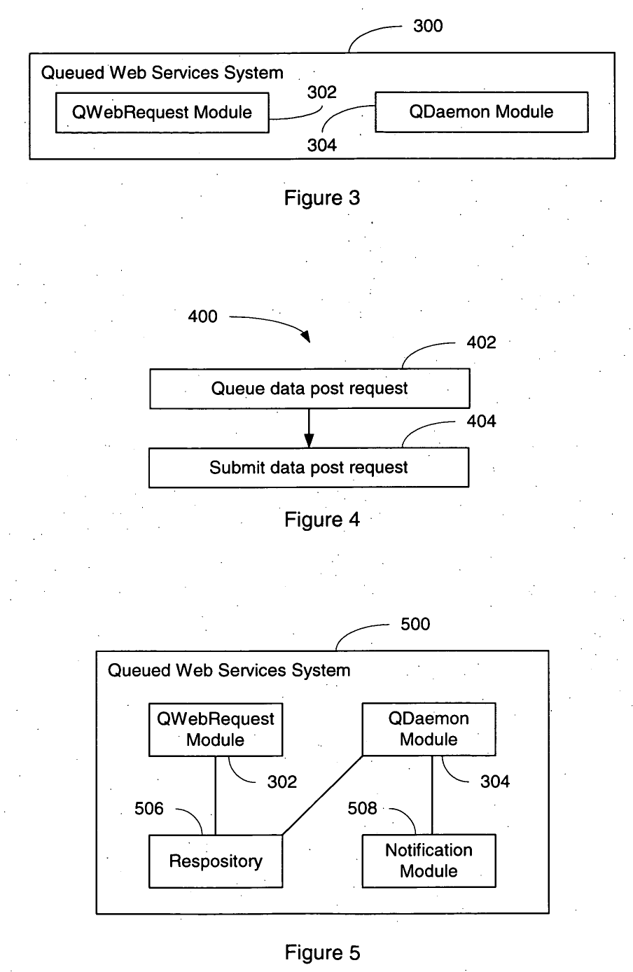

FIG. 3 shows a queued web services system 300 for queuing web services, in accordance with an embodiment of the invention. The queued web services system 300 comprises a QWebRequest module 302 for queuing the requests, and a QDaemon module 304 for monitoring the queue for messages and sending requests from the queue to the host 108 through the IIS 206. The QWebRequest module 302 handles hyper-text transfer protocol queue (httpq) requests, and hyper-text transfer protocol for secure communication queue (httpsq) requests. Periodically, the QDaemon module 304 checks if there are any messages in the queue, and if there are, the QDamon attempts to post them to the server. Other components may be added to the queued web services system 300, including a repository for saving or caching data post requests to be submitted at a later date, a notification system for determining if a connection is available, and an event listener module for listening for web service events.

The queued web services system 300 may be used by the application running within an application console of a mobile device 102. Web service requests can be divided into two categories: data request (return value is expected) and data post (no return value is expected). When a data post is submitted, this web service request is queued in a local queue and is submitted by the QDaemon module 304 when the Internet connection and/or server are available. The order of posts is guaranteed as is the delivery. The order is guaranteed by numbering the requests that are sent in FIFO (first in first out) order. Guaranteeing the order of posts is advantageous since the order of the operations in enterprise resource planning (ERP) systems is important. The delivery is guaranteed by reposting until the server accepts the request: attempt to post, fail, wait and try again. A failed message remains in front of the queue until sent successfully. Preferably, no other message can get in front of it.

Advantageously, the queued web services system 300 allows the data post web request to he handled transparently even if the Internet (and thus web server) is not available. Data is posted on the server when a connection is available. In one embodiment, a data request is queued while the user waits to be notified when the data request (or message) is successful. When the message is successfully sent to the server at the later time, the system will raise the event to the calling application. The application, if listening to this event, can than notify the user about the success. If the solution does not require the user to know about the success of the message, the application will simply not listen for this event. Advantageously, this solves the problem with the type of the web request where the return value is expected (the data request). When the event is raised, the returned data will be made available to the application. Advantageously, a user does not need to wait for the data to arrive and can work on something else. How the actual application takes advantage of this depends on the requirements of that application. The application developer can utilize this advantage as desired.

Advantageously, the architecture of the queued web services system 300 is transparent to the user. A user does not have to actively initiate the data posts once a connection is available. The user does not need to know or care if she is connected to the Internet or any other communications network. Therefore, a user does not need to distinguish between connected and disconnected state.

Typically, a web service is referenced in an application by uniform resource locator (URL) in the form http://server/servicedirectory/service or https:H/server/servicedirectory/service for secure communication. To instruct the system that a queued web service call should be used, an application developer may replace the URLs with httpq://server/servicedirectory/service or httpsq://server/servicedirectory/service for secure communication. Web'services is an open, well known and widely used W3C standard, and the developer does not need to learn or purchases any new technology.

FIG. 4 shows in a flowchart an example of a method of queuing web services (400), in accordance with an embodiment of the queued web services system 300. The method (400) comprises the steps of queuing a data post request (402), and submitting the data post request (404) when a connection is available. Other steps may be added to the method (400) including receiving the data post request, checking to see if a connection is available, saving or caching information to be posted at a later date, and listening for web service events.

FIG. 5 shows another example of a queued web services system 500. The queued web services system 500 comprises the QWebRequest module 302, the QDaemon module 304, a repository 506 for saving or caching data post requests to be submitted at a later date, and a notification system 508 for determining if a network connection is available. The QWebRequest module 302 communicates with the repository 506 to store or cache data post requests. The QDaemon module 304 communicates with the repository 506 to obtain data post requests and with the notification module 508 for receiving notification that a network connection is available. Other components may be added to the queued web services system 500.

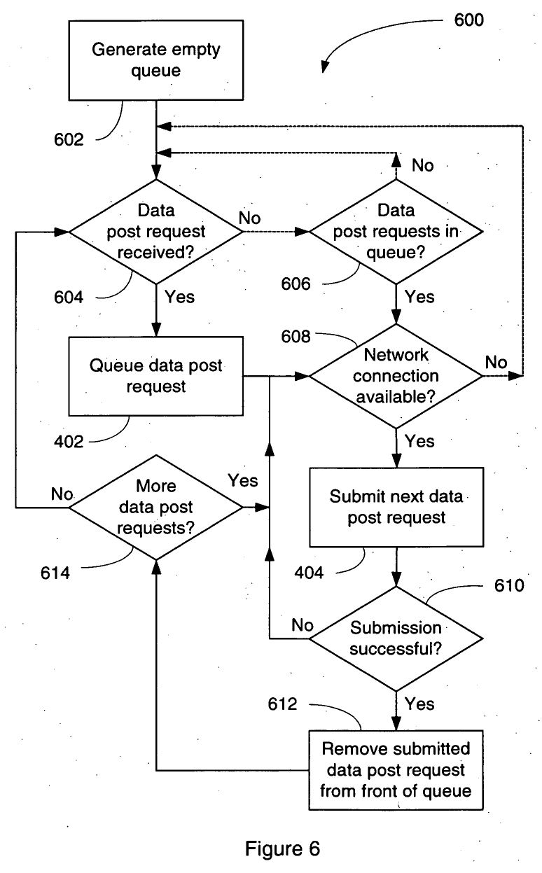

FIG. 6 shows in a flow chart another example of a method of a method of queuing web services (600), in accordance with an embodiment of the queued web services system. 300, 500. The method (600) includes the step of generating an empty queue to store data request posts (602). Once the queue is generated (602), the method waits for an application to make a data post request (web service request). If a data post request is received (604), then the data post request is queued (402). If not (604), then the method continues waiting until a data post request is received. Alternatively, as shown in stippled lines in FIG. 6, if a data post request is not received (604), a the queue is monitored to see if there are any data posts requests to submit (606). In another alternative, step (606) may be a first step in a separate thread that begins a method that does not include steps (602) to (402).

Once the data post request is queued (402), or if the queue has a data post request to submit (606), the network is monitored to see if a network connection is available (608). One example of monitoring for a network connection is a trial-and-error method that attempts a communication to check if it is successfully. Alternatively, a ping may be used. If a network connection is available (608), then the next data post request at the front of the queue submitted (404). If the submission is successful (610), data post request (or message) is removed from the queue (610). Otherwise (610), the method repeats step (608) to check for a network connection. If there are more data post requests to submit (614), then steps (610) to (614) are repeated. Once there are no more data post requests to submit (610), step (604) is repeated. Alternatively, the method may wait a period of time and then repeat (606). Other steps may be added to the method (600), including listening for web service events, and obtaining the queue from, and storing the queue to, a repository or cache.

Preferably, the queued web services system 300, 500 is installed in an application console on each mobile device, the application console including its own communication server, database layer and business logic. These components offer enterprise-level capabilities to users to implement tried-and-true business processes whether online or offline. Advantageously, the application console having a queued web services system 300, 500 provides seamless network connectivity, advanced data synchronization, and automatic application deployment and upgrades. Superior localization features provide support for a global user community.

The queued web services system 300, 500 manages network connectivity so a client application 202 can focus on business logic. The queued web services system 300 detects when a device is out of network coverage (or undocked) and queues requests to the IIS 206 server, seamlessly sending the requests when a network is available. Among other methods, the detection can be by trial-and-error, or by using a ping. Whether online or offline, at the plant or in the field, the queued web services system 300, 500 enables the mobile worker to concentrate on the job at hand.

Advantageously, the queue web services system 300, 500 allows an organization to connect its mobile workforce to its enterprise to provide real-time information at the point of work, save time and reduce errors. Field workers can make better decisions and respond to change faster using devices designed specifically for the mobile environment. Implemented in a design, development and operational environment 100, 200 for deploying feature rich applications to mobile devices and desktop personal computers, the queued web services system 300, 500 allows for a seamless “sometimes connected” operation so that the mobile worker can move from connected to disconnected situations without interrupting the work process. Advantageously, the queued web services system 300, 500 is a scaleable architecture enabling the integration of large scale, mobile solutions.

Advantageously, the queued web services system 300, 500 helps mobilizes enterprise applications specific to an organization's needs to ensure that they gain immediate business value. Whether it is supply chain management (SCM), asset life-cycle management (ALM), or customer relationship management (CRM) the queued web services system 300, 500 helps extend the organization's business scenarios beyond its four walls, empowering business mobility, connecting a mobile workforce to the enterprise.

The queued web services system and method according to the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A queued web services system for queuing web services, the queued web services system comprising:
a QWebRequest module for queuing a data post request in a queue, and
a QDaemon module for monitoring the queue and submitting the data post request from the queue.

2. The queued web services system as claimed in claim 1, wherein a plurality of data post requests are queued and submitted from the queue.

3. The queued web services system as claimed in claim 2, wherein the data post request are submitted from the queue in the order that they were queued.

4. The queued web services system as claimed in claim 1, further comprising a repository for storing data post requests when a network connection is not available through which to submit the data post request.

5. The queued web services system as claimed in claim 1, further comprising a notification system for determining if a network connection is available through which to submit a data post request.

6. The queued web services system as claimed in claim 1, further comprising an event listener module for listening for web service events.

7. A method of processing queued web services, the method comprising the steps of:
monitoring a queue for data posts requests to submit; and
submitting a data post request from the queue when a connection is available.

8. The method as claimed in claim 7, further including the step of monitoring a network for a network connection.

9. The method as claimed in claim 7, wherein the step of submitting a data post request includes the step of removing the data post request at the front of the queue.

10. The method as claimed in claim 7, further including the step of storing the queue to a repository.

11. A method of queuing web services, the method comprising the steps of:
queuing a data post request in a queue; and
submitting the data post request when a connection is available.

12. The method as claimed in claim 11, further including the step of monitoring the queue for data posts requests to submit.

13. The method as claimed in claim 11, further including the step of generating an empty queue to store data request posts.

14. The method as claimed in claim 11, further including the step of receiving a data post request.

15. The method as claimed in claim 11, further including the step of monitoring a network for a network connection.

16. The method as claimed in claim 11, wherein the step of submitting a data post request includes the step of removing the data post request at the front of the queue.

17. The method as claimed in claim 11, further including the step of obtaining the queue from a repository.

18. The method as claimed in claim 11, further including the step of storing the queue to a repository.

19. The method as claimed in claim 11, further including the step of listening for a web service event.
